(19) United States
(12) Patent Application Publication
(10) Pub. No.: US 2026/0303589 A1
(43) Pub. Date: Oct. 1, 2026

(54) COMMUNICATION DEVICE AND NON-TRANSITORY COMPUTER-READABLE RECORDING MEDIUM STORING COMPUTER-READABLE INSTRUCTIONS FOR COMMUNICATION DEVICE

(71) Applicant: BROTHER KOGYO KABUSHIKI KAISHA, Nagoya (JP)

(72) Inventor: Akihito UNO, Iwakura (JP)

(21) Appl. No.: 19/631,298

(22) Filed: Mar. 27, 2026

(30) Foreign Application Priority Data
Mar. 31, 2025 (JP) 2025-059682

(51) Int. Cl. H04L 9/40

(52) U.S. Cl. CPC H04L 63/083

(57) ABSTRACT

A communication device may include: a memory configured to store a first token which is used in access to a server on the Internet; and a controller configured to: in a case where the communication device receives application information for applying for usage of the communication device from a user in a situation where a state of the communication device is a first state where the usage of the communication device is not allowed, execute inquiry to the server using the application information and the first token; and in a case where a predetermined answer indicating that the application information is registered in the server is received from the server in response to the inquiry to the server using the application information and the first token, change the state of the communication device from the first state to a second state where the usage of the communication device is allowed.

### REFERENCE TO RELATED APPLICATIONS

This application claims priority to Japanese Patent Application No. 2025-059682 filed on Mar. 31, 2025. The entire content of the priority application is incorporated herein by reference.

### BACKGROUND

A multifunction device is known. When the multifunction device reads card identification information from a card, the multifunction device performs user authentication. When the user authentication succeeds, the multifunction device displays the personal information of a card holder.

This specification provides a technology for managing a usage application for using a communication device in a server.

### SUMMARY

A communication device disclosed herein may include: a memory configured to store a first token which is used in access to a server on the Internet; and a controller configured to: in a case where the communication device receives application information for applying for usage of the communication device from a user in a situation where a state of the communication device is a first state where the usage of the communication device is not allowed, execute inquiry to the server using the application information and the first token; and in a case where a predetermined answer indicating that the application information is registered in the server is received from the server in response to the inquiry to the server using the application information and the first token, change the state of the communication device from the first state to a second state where the usage of the communication device is allowed.

According to the above configuration, a user can apply to the server for the usage of the communication device by utilizing the first token.

A non-transitory computer-readable recording medium storing computer-readable instructions for realizing the above-described communication device is also novel and useful. A control method for the above communication device is also novel and useful.

### BRIEF DESCRIPTION OF DRAWINGS

FIG. 1 is a block diagram of a communication system.

FIG. 2 is a sequence diagram of process of issuing a token.

FIG. 3 is a continuation of FIG. 2.

FIG. 4 is a sequence diagram of a registration process.

FIG. 5 is an embodiment of a continuation of FIG. 4.

FIG. 6 is an embodiment of the continuation of FIG. 4.

### DESCRIPTION

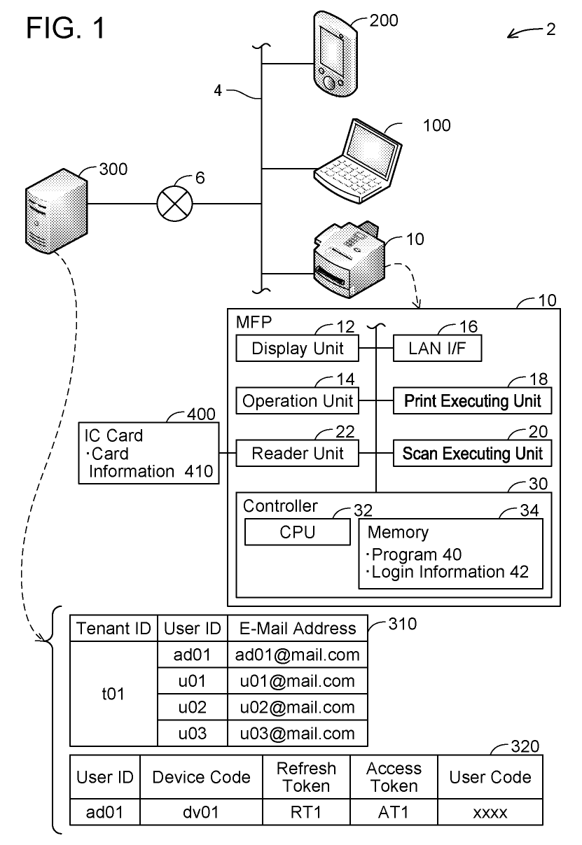

### Configuration of Communication System 2; FIG. 1

A communication system 2 comprises an MFP 10, an administrator terminal 100, a user terminal 200, and a server 300. The MFP 10 is a device with multiple functions including printing and scanning functions. “MFP” stands for a Multifunction Peripheral. The administrator terminal 100 and the user terminal 200 may be laptop PCs, desktop PCs, tablet terminals, smartphones, etc.

The MFP 10, the administrator terminal 100, and the user terminal 200 are used in a specific organization. The specific organization may be, for example, a corporation, an office, a department within a company, etc. The administrator terminal 100 is a terminal device used by an administrator belonging to the specific organization. The user terminal 200 is a terminal device used by a user who belongs to the specific organization and is managed by the administrator. Here, the specific organization has one or more users per administrator. Therefore, there may be multiple user terminals 200 in the specific organization.

The MFP 10, the administrator terminal 100, and the user terminal 200 are connected to a LAN 4. “LAN” stands for Local Area Network. The LAN 4 may be wireless or wired. The administrator terminal 100 and the user terminal 200 are configured to communicate with the MFP 10 via the LAN 4.

The LAN 4 is connected to the Internet 6. The devices connected to the LAN 4, e.g. MFP 10, can communicate with the server 300 via the Internet 6 and LAN 4.

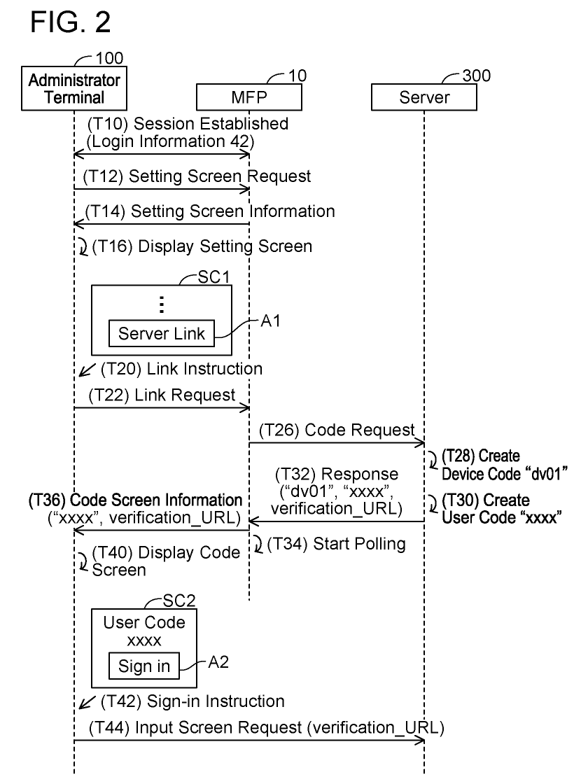

### Configuration of MFP 10; FIG. 2

The MFP 10 comprises a display unit 12, an operation unit 14, a LAN interface 16, a print executing unit 18, a scan executing unit 20, a reader unit 22, and a controller 30. Hereinafter, “interface” may be referred to as “I/F”.

The display unit 12 is a display or panel for showing various information. The panel may or may not be a touch panel. The panel may be, for example, an LCD panel or an OLED panel. The operation unit 14 is a user interface that allows the user to input various types of information to the MFP 10. The operation unit 14 comprises, for example, software key(s), i.e., a touch panel for displaying operation object(s), hardware key(s), or both. The hardware key(s) are, for example, button(s), switch(es), etc.

The LAN I/F 16 is an interface for communication via the LAN 4. The LAN I/F 16 is connected to the LAN 4. The print executing unit 18 is hardware configured to print on a print medium in accordance with print data. The print executing unit 18 is realized, for example, by an inkjet method and/or an electrophotographic method. The scan executing unit 20 is hardware configured to scan a document. The scan executing unit 20 comprises a scanner engine that has an image sensor such as a Charge-Coupled Device (CCD) or Contact Image Sensor (CIS).

The reader unit 22 is a device configured to read information from an IC card 400. The reader unit 22 includes an antenna for communicating with the IC card 400. The reader unit 22 is a so-called card reader. Card information 410 is stored in the IC card 400. The card information 410 is, for example, an identifier assigned to the IC card 400.

The controller 30 comprises a CPU 32 and a memory 34. The memory 34 comprises a main storage and an auxiliary storage. Although this is an example, the main storage includes RAM and cache memory. Although this is an example, the auxiliary storage device may be ROM, flash memory, Solid State Drive (SSD), Hard Disk Drive (HDD), or a combination thereof. The CPU 32 performs various processes according to the program 40 loaded from the auxiliary storage to the main storage.

The MFP 10 has a server function that provides a setting screen for changing settings of the MFP 10. The memory 34 stores login information 42 for logging into a server function of the MFP 10. The login information 42 is, for example, a user name and password.

### Configuration of Server 300; FIG. 1

The server 300 provides a service which manages accounts of users belonging to an organization. The service is, for example, Microsoft Entra ID (registered trademark). The server 300 stores an account table 310 and a token table 320.

The account table 310 manages information about users belonging to an organization. The account table 310 stores a tenant ID, a user ID, and an email address in association with each other. The tenant ID is an identifier that identifies the organization. The user ID is an identifier that identifies the user. The user ID is a so-called account name. Although not shown in the figures, each user ID is stored with a password in association therewith. For example, as shown in FIG. 1, one tenant ID “t01” is associated with four user IDs “ad01”, “u01”, “u02”, and “u03”. Here, the user ID “ad01” identifies the administrator who belongs to the specific organization identified by the tenant ID “t01”. Each of user IDs “u01”, “u02”, and “u03” identifies a user other than the administrator who belongs to the specific organization identified by the tenant ID “t01”. In the following, the user ID identifying the administrator will be described as an administrator ID. The user ID that identifies a user other than the administrator will be described as an individual user ID.

In this embodiment, the administrator ID “ad01” is stored in association with administrator privilege information indicating privilege(s) of the administrator. The administrator privilege information indicates the privilege to access information stored in association with the tenant ID “t01”. This information includes, for example, email address(es) stored in association with the tenant ID “t01”. Furthermore, each of the individual user IDs is stored in association with individual privilege (i.e., individual authorization) information indicating the privilege of the user (i.e., authorization given to the user) identified by that individual user ID. The individual privilege information indicates the privilege to access information stored in association with the corresponding individual user ID. On the other hand, the individual privilege information does not indicate the privilege to access information stored in association with other user ID(s). In a modification, the individual privilege information may indicate the privilege to access multiple email addresses. For example, the individual privilege information corresponding to the individual user ID “u01” may indicate privilege to access not only the email address stored in association with individual user ID ‘u01’, but also the email address stored in association with another user ID “u02”.

The token table 320 manages token(s). A token is authentication information issued by the server 300. The token table 320 stores a user ID, a device code, a refresh token, an access token, and a user code in association with each other. The device code is a code assigned to a device such as the MFP 10. The user code is a code assigned to a user. The access token is a token with a predetermined expiration. The refresh token is a token used to update the access token. In a modification, the access token may not have an expiration.

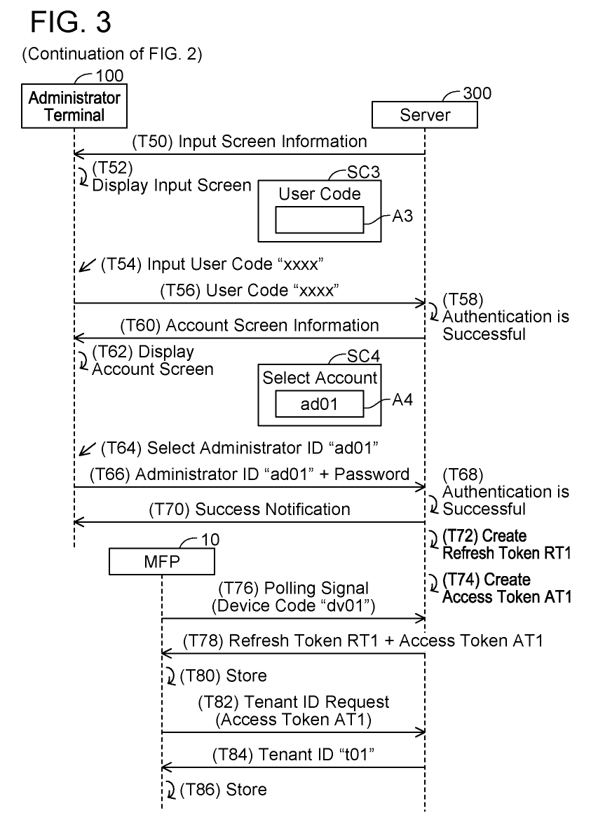

### Process of Issuing Token; FIGS. 2 and 3

With reference to FIGS. 2 and 3, process of issuing a token will be described. In the following description, process executed by the MFP 10 is realized by the CPU 32 of the MFP 10, which operates according to the program 40. Communication between devices is executed via the LAN 4, the Internet 6, and the LAN I/F 16. In the following, when communication between devices is described, descriptions of the LAN 4, the Internet 6, and the LAN I/F 16 will be omitted.

In T10, the administrator terminal 100 logs into the server function of the MFP 10 using the login information 42. Due to this, a login session is established between the administrator terminal 100 and the MFP 10. In the following process, the login session is used for communication between the administrator terminal 100 and the MFP 10.

In T12, the administrator terminal 100 sends a setting screen request for requesting setting screen information to the MFP 10. The setting screen information is information corresponding to a setting screen SC1 for changing the settings of the MFP 10.

In T14, the administrator terminal 100 receives the setting screen information from the MFP 10 as a response to the setting screen request in T12. In T16, the administrator terminal 100 displays the setting screen SC1. The setting screen SC1 includes a plurality of icons corresponding to various settings of the MFP 10. The setting screen SC1 includes an icon A1 that receives an instruction to start a linkage with the server 300 from the user.

When the administrator terminal 100 detects selection of the icon A1 in the setting screen SC1 in T20, the administrator terminal 100 sends a link request to the MFP 10 in T22. The link request is a signal for requesting to start a link with the server 300.

When the MFP 10 receives the link request from the administrator terminal 100 in T22, the MFP 10 sends a code request to the server 300 in T26. The code request is a signal for requesting a device code and a user code.

When the server 300 receives the code request from the MFP 10 in T26, the server 300 creates the device code “dv01” in T28. Furthermore, the server 300 creates a user code “xxxx” in T30. The server 300 stores the user code “xxxx” in the token table 320 in association with the device code “dv01”.

In T32, the server 300 sends a response to the code request to the MFP 10. The response includes the device code “dv01” created in T28, the user code “xxxx” created in T30, and a ‘verification_URL’. The ‘verification_URL’ is a URL for accessing input screen information corresponding to an input screen SC3 for inputting the user code. FIG. 3 shows an example of the input screen SC3.

When the MFP 10 receives the response from the server 300 in T32, the MFP 10 starts repeatedly sending polling signals to the server 300 in T34. The polling signal is a signal to confirm that a token has been issued. The polling signal includes the device code “dv01” received in T32.

In T36, the MFP 10 sends code screen information corresponding to a code screen SC2 which displays the user code to the administrator terminal 100. The code screen information includes the user code “xxxx” and the ‘verification_URL’.

When the administrator terminal 100 receives the code screen information from the MFP 10 in T36, the administrator terminal 100 displays the code screen SC2 in T40. The code screen SC2 includes a character string indicating the user code “xxxx” and an icon A2. The icon A2 is an icon that receives an instruction to sign in to the server 300 from the user.

When the administrator terminal 100 detects selection of the icon A2 in the code screen SC2 in T42, the administrator terminal 100 sends an input screen request to the server 300 in T44. The input screen request is a signal for requesting the input screen information and includes the ‘verification_URL’.

In T50 in FIG. 3, the administrator terminal 100 receives the input screen information as a response to the input screen request in T42. In T52, the administrator terminal 100 displays the input screen SC3. The input screen SC3 includes an input field A3 for inputting a user code.

In T54, the administrator terminal 100 detects the input of the user code “xxxx” in the input field A3. In T56, the administrator terminal 100 sends the user code “xxxx”, which had been inputted to the input field A3, to the server 300.

When the server 300 receives the user code “xxxx” from the administrator terminal 100 in T56, the server 300 authenticates the user code “xxxx” received from the administrator terminal 100. In this case, the user code “xxxx” received from the administrator terminal 100 matches the user code “xxxx” stored in the token table 320. Therefore, in T58, the authentication of the user code "xxxx" succeeds.

When the authentication of the user code “xxxx” succeeds, the server 300 sends account screen information to the administrator terminal 100 in T60. The account screen information corresponds to an account screen SC4 for selecting a target account name for which the token should be issued.

When the administrator terminal 100 receives the account screen information from the server 300 in T60, the administrator terminal 100 displays the account screen SC4 in T62. The account screen SC4 includes an icon A4 for selecting a target account name from the account name(s) stored in the administrator terminal 100. In this case, the administrator ID “ad01” is stored in the administrator terminal 100 as an account name. Due to this, the administrator ID “ad01” is displayed on the icon A4. If multiple account names are stored in the administrator terminal 100, multiple icons A4 are displayed on the account screen SC4. The account screen SC4 may also include an icon for creating a new account and an input field for entering a new account name and password. In this case, the administrator selects the icon A4 in the account screen SC4.

The administrator terminal 100 proceeds to T66 when detecting selection of the icon A4 in the account screen SC4 in T64. In T66, the administrator terminal 100 sends the administrator ID “ad01” corresponding to the icon A4 and the password to the server 300.

In T66, when the server 300 receives the administrator ID “ad01” and the password from the administrator terminal 100, the server 300 authenticates the administrator ID “ad01” and the password. In this case, the administrator ID “ad01” and the password are stored in the account table 310. Due to this, in T68, the authentication of the administrator ID “ad01” and password succeeds. The successfully authenticated administrator ID “ad01” is stored in the token table 320 in association with the user code “xxxx” and the device code “dv01”.

When the authentication of the administrator ID “ad01” and the password succeeds in T68, the server 300 proceeds to T70. In T70, the server 300 sends a success notification indicating that the authentication was successful to the administrator terminal 100. Further, in T72, the server 300 creates a refresh token RT1. In the subsequent T74, the server 300 creates an access token AT1 based on the refresh token RT1. The server 300 then stores the tokens RT1 and AT1 in the token table 320 in association with the administrator ID “ad01” and the device code “dv01”.

Between T36 in FIG. 2 and T74 in FIG. 3, the MFP 10 repeatedly sends polling signals including the device code “dv01” to the server 300. In T76, the server 300 receives a polling signal from the MFP 10 after the tokens RT1 and AT1 have been created. In T78, the server 300 sends the tokens RT1 and AT1, which are stored in association with the device code “dv01” included in the polling signal, to the MFP 10.

When the MFP 10 receives the tokens RT1 and AT1 from the server 300 in T78, the MFP 10 stores the tokens RT1 and AT1 in the memory 34 in T80.

In the following T82, the MFP 10 sends a tenant ID request for requesting a tenant ID to the server 300. The tenant ID request includes the access token AT1.

The server 300 receives the tenant ID request from the MFP 10 in T82 and proceeds to T84. The server 300 identifies the management identifier “ad01” stored in association with the access token AT1 within the tenant ID request from the token table 320 in T84. The server 300 then sends the tenant ID “t01” stored in the account table 310 in association with the identified management identifier “ad01” to the administrator terminal 100.

The MFP 10 receives the tenant ID “t01” from the server 300 in T84, and stores the tenant ID “t01” in the memory 34 in T86.

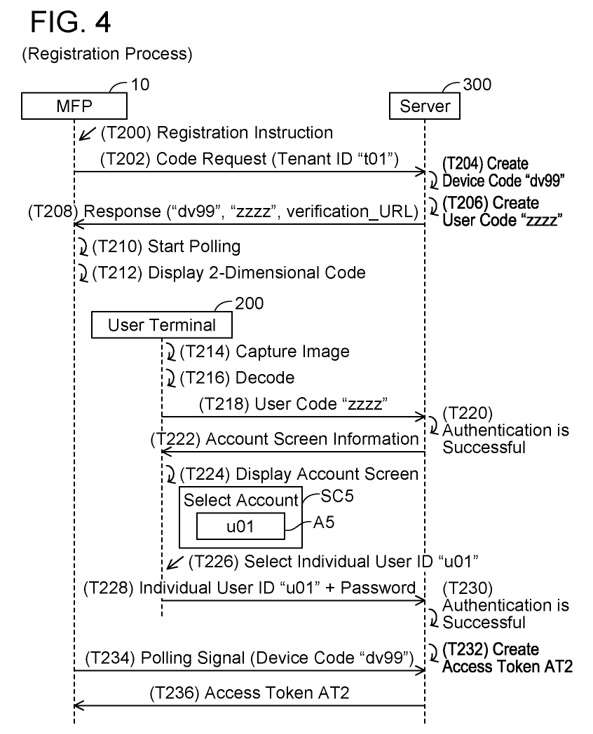

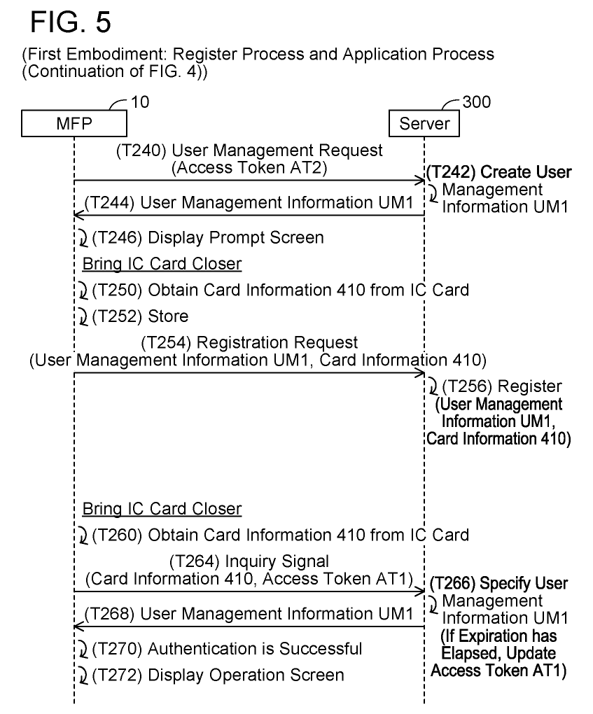

### Registration process and Authentication Process; FIGS. 4 and 5

FIGS. 4 and 5 are sequence diagrams showing a registration process of registering the card information 410 to the server 300 and application process for applying to use the MFP 10. The processes in FIGS. 4 and 5 can be executed after the processes in FIGS. 2 and 3.

The user inputs a registration instruction to the operation unit 14 of the MFP 10 in T200. The registration instruction is an instruction to start registering the card information 410.

When the MFP 10 detects the input of the registration instruction in T200, the MFP 10 proceeds to T202.

In T202, the MFP 10 sends a code request including the tenant ID “t01” stored in the memory 34 to the server 300. The code request in T202 is the same as the code request in T26 in FIG. 2, except that it includes the tenant ID “t01”.

Process of T204 and T206 are similar to T28 and T30 in FIG. 2, except that the device code “dv99” and the user code “zzzz” are created. T208 and T210 are the same as T32 and T34 in FIG. 2, except that the device code “dv99” and the user code “zzzz” are used.

In the following T212, the MFP 10 displays a two-dimensional code on the display unit 12. The two-dimensional code is an image encoded with the ‘verification_URL’ and the user code “zzzz” received from the server 300.

In T214, the user operates the user terminal 200 to capture the two-dimensional code displayed in T212. Due to this, in T216, the user terminal 200 decodes the two-dimensional code and obtains the ‘verification_URL’ and the user code “zzzz”.

In T218, the user terminal 200 sends the user code “zzzz” to the server 300 using the ‘verification_URL’.

When the server 300 receives the user code “zzzz” from the user terminal 200 in T218, the server 300 authenticates the user code “zzzz” received from the user terminal 200. In this case, the user code “zzzz” received from the user terminal 200 matches the user code “zzzz” stored in the token table 320. Due to this, in T220, the authentication of the user code “zzzz” succeeds.

When the authentication of the user code “zzzz” succeeds, the server 300 sends the account screen information to the user terminal 200 in T222.

When the user terminal 200 receives the account screen information from the server 300 in T222, the user terminal 200 displays the account screen SC4 in T224. In this case, the individual user ID “u01” is stored in the user terminal 200 as an account name. The account screen SC4 includes an icon A5 on which the individual user ID “u01” is displayed.

When the user terminal 200 detects selection of the icon A5 in the account screen SC4 in T226, the user terminal 200 proceeds to T228. In T228, the user terminal 200 sends the individual user ID “u01” corresponding to the icon A5 and the password to the server 300.

When the server 300 receives the individual user ID “u01” and password from the user terminal 200 in T228, the server 300 authenticates the individual user ID “u01” and password. In this case, the individual user ID “u01” and password are successfully authenticated in T230. The individual user ID “u01” that has been successfully authenticated is stored in association with the device code “dv99” and stored in the token table 320. Next, the server 300 creates the access token AT2, and stores the access token AT2 in the token table 320 in association with the device code “dv99”.

The access token AT2 has the privilege (i.e., authorization) to access information stored in association with the individual user ID “u01”. However, the access token AT2 does not have the privilege to access information other than that stored in association with the individual user ID “u01”. Contrary to this, the access token AT1, created in T74 in FIG. 3, has the privilege to access information stored in association with the tenant ID “t01”. The access token AT1 has the privilege to access not only information associated with the individual user ID “u01” but also information associated with other individual user ID(s). This is because the access token AT1 is associated with the administrator privilege information that holds a broader privilege.

In T234, the server 300 receives a polling signal from the MFP 10 after the access token AT2 has been created. In T236, the server 300 sends the access token AT2 stored in association with the device code “dv99” included in the polling signal to the MFP 10.

In the following T240 in FIG. 5, the MFP 10 sends a user management request requesting user management information to the server 300. The user management information is information used by the server 300 to manage user(s) and is issued by the server 300. The user management request includes the access token AT2.

When the server 300 receives the user management request from the MFP 10 in T240, the server 300 proceeds to T242. In T242, the server 300 creates user management information UM1. The server 300 stores the user management information UM1 in association with the access token AT2 and the individual user ID “u01”. In the subsequent T244, the server 300 sends the user management information UM1 to the MFP 10.

When the MFP 10 receives the user management information UM1 from the server 300 in T244, the MFP 10 proceeds to T246. In T246, the MFP 10 displays a prompt screen on the display unit 12. The prompt screen is a screen which prompts the user to bring the IC card 400 close to the reader unit 22. The user, seeing the prompt screen, brings the IC card 400 close to the reader unit 22.

In T250, the MFP 10 obtains the card information 410 from the IC card 400 via the reader unit 22. In T252, the MFP 10 stores the user management information UM1 received in T242 in the memory 34. In T254, the MFP 10 sends a registration request which requests registration of the card information 410 to the server 300. The registration request includes the user management information UM1 and the card information 410.

When the server 300 receives the registration request from the MFP 10 in T254, the server 300 proceeds to T256. In T256, the server 300 stores the card information 410 included in the registration request in association with the user management information UM1 included in the registration request. This registers the card information 410 in association with the individual user ID “u01”.

In this embodiment, the user applies to use the MFP 10 using the IC card 400. In response to success of the application using the IC card 400, the user is authorized to use the MFP 10. When the authorization to use the MFP 10 is not granted, the MFP 10 displays an application screen on the display unit 12. The application screen is a screen used to submit an application using the IC card 400. While the application screen is displayed, the user cannot use the MFP 10.

The user brings the IC card 400 close to the reader unit 22 of the MFP 10 while the application screen is displayed. In T260, the MFP 10 obtains the card information 410 from the IC card 400 via the reader unit 22.

In T264, the MFP 10 sends an inquiry signal to the server 300. The inquiry signal is a signal for inquiring the server 300 about information for authorizing the user to use the MFP 10. The inquiry signal includes the card information 410 obtained in T260 and the access token AT1.

When the server 300 receives the inquiry signal from the MFP 10 in T264, the server 300 proceeds to T266. In T266, the server 300 uses the access token AT1 to specify the user management information UM1 stored in association with the card information 410 in the inquiry signal. As described above, this is because the access token AT1 possesses the privilege to access information stored in association with the individual user ID “u01”.

In T268, the server 300 sends the user management information UM1 identified in T266 to the MFP 10.

When the MFP 10 receives the user management information UM1 from the server 300 in T268, the MFP 10 proceeds to T270. In T270, the MFP 10 authenticates the user management information UM1 received in T268. In this case, the user management information UM1 is stored in the memory 34 in T252. Since the user management information UM1 received in T268 matches the user management information UM1 in the memory 34, the authentication of the user management information UM1 received in T268 succeeds. When the authentication of T270 succeeds, the MFP 10 proceeds to T272. If the authentication of T270 fails, the process of T272 is not executed, and the process in FIG. 5 ends.

In T272, the MFP 10 displays an operation screen on the display unit 12 instead of the application screen. The operation screen is a screen for using the MFP 10. For example, the operation screen includes icon(s) for using a printing function and/or a scanning function. That is, displaying the operation screen permits the usage of the MFP 10.

### Effect of Present Embodiment

According to the present embodiment, the inquiry signal including the access token AT1 can be used to apply to the server 300 for the usage of the MFP 10. Furthermore, the inquiry signal includes the card information 410 read from the IC card 400. By registering the card information 410 to the server 300, the application for using the MFP 10 can be performed using the IC card 400.

Furthermore, a situation where the access token AT1 has expired at the time the inquiry signal is received in T264 may be assumed. In this case, the server 300 uses the refresh token RT1 to update the access token AT1. This allows the processes from T268 onwards to be executed even when the access token AT1 has expired. In a modification, the access token AT1 may be updated at a timing other than when the inquiry signal is received in T264.

Furthermore, the registration process is initiated by the code request including the tenant ID “t01” as a trigger. The tenant ID “t01” is obtained using the access token AT1 corresponding to the administrator ID “ad01” (T84 in FIG. 2). That is, the registration process in FIGS. 4 and 5 is executed under the conditions of both the authentication using the administrator ID and the authentication using an individual user ID.

### Correspondence Relationships

The MFP 10, the reader unit 22, and the memory 34 are examples of “communication device,” “reader unit,” and “memory,” respectively. The server 300, the access token AT1, and the access token AT2 are examples of “server,” “first token,” and “second token,” respectively. The card information 410 is an example of “application information”. The state where the application screen is displayed and the state where the operation screen is displayed are examples of “first state” and “second state”, respectively. The user management information UM1 in T268 of FIG. 5 is an example of “predetermined answer”. The processes in FIGS. 2 and 3 and the administrator ID “ad01” are examples of “first user authentication” and “first user identifier,” respectively. The processes of T204 to T236 in FIG. 4 and the individual user ID “u01” are examples of “second user authentication” and “second user identifier,” respectively. The code request in T202 of FIG. 4 and the tenant ID “t01” are examples of “start instruction” and “organization identifier,” respectively. T256 in FIG. 5 is an example of “registration process.” The user management information UM1 is an example of “specifying information.”

T264 and T272 in FIG. 5 are respectively examples of processes realized by “execute inquiry to the server” and “change the state of the communication device”.

### Second Embodiment

In this embodiment, a PIN code arbitrarily set by a user is used instead of the IC card 400. This embodiment has the same configuration as the first embodiment, except that the content of the registration process and the application process differ. Here, in this embodiment, the MFP 10 may not include the reader unit 22.

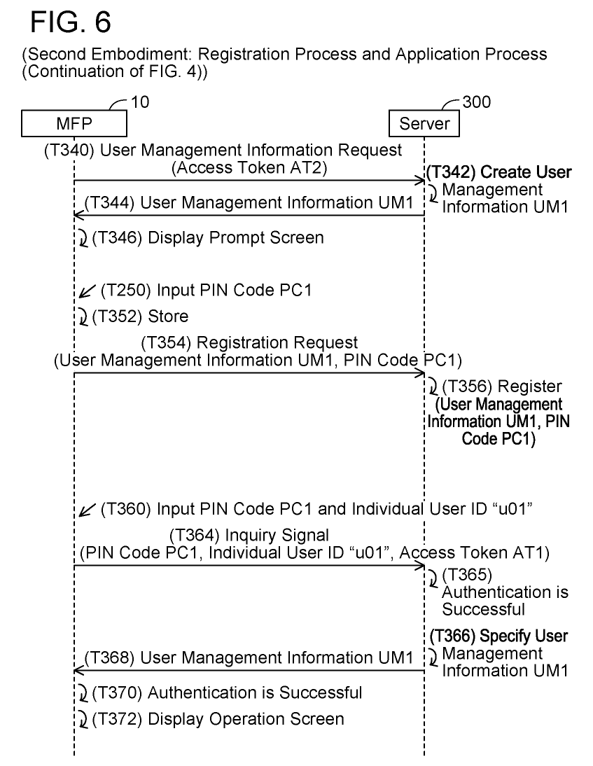

### Registration process and Application Process; FIG. 6

FIG. 6 is a continuation from FIG. 4. T340 to T344 are the same as T240 to T244 in FIG. 5. In T346, the MFP 10 displays a prompt screen prompting the user to enter a PIN code on the display unit 12. This prompt screen includes an input field for inputting a PIN code. In this case, the user manually enters a PIN code PC1 into the input field on the prompt screen.

When the MFP 10 detects the input of the PIN code PC1 in T350, the MFP 10 proceeds to T352. T352 is the same process as T252 in FIG. 5. T354 is the same process as T254 in FIG. 5, except that the PIN code PC1 is included in the registration request instead of the card information 410. T356 is the same process as T256 in FIG. 5, except that the PIN code PC1 is registered instead of the card information 410.

In this embodiment, the user applies to use the MFP 10 using the PIN code PC1. The user inputs the PIN code PC1 and the individual user information “u01” by following the application screen. When the MFP 10 detects the input of the PIN code PC1 and the individual user information “u01” in T360, the MFP 10 proceeds to T364.

In T364, the MFP 10 sends an inquiry signal including the PIN code PC1, the individual user information “u01”, and the access token AT1 to the server 300.

When the server 300 receives the inquiry signal from the MFP 10 in T364, the server 300 proceeds to T365. In T365, the server 300 uses the access token AT1 to specify the list of user ID(s) stored in association with the tenant ID “t01”. Then, the server 300 determines whether the individual user ID “u01” included in the inquiry signal exists in the specified list. When the individual user ID “u01” included in the inquiry signal exists among the specified user ID(s), authentication of the individual user ID “u01” in the inquiry signal succeeds.

In this case, the authentication of the individual user ID “u01” in the inquiry signal succeeds, and the server 300 proceeds to T366. If the authentication of the individual user ID “u01” in the inquiry signal fails, processes after T366 are not executed, and the process in FIG. 6 ends.

In T366, the server 300 uses the access token AT1 to specify the user management information UM1 stored in association with the PIN code PC1 in the inquiry signal. T368 to T372 are the same as T268 to T272 in FIG. 5.

### Effect of Present Embodiment

In this embodiment, by registering the PIN code PC1 to the server 300, application to use the MFP 10 can be conducted using the PIN code PC1.

Furthermore, in this embodiment, in addition to the PIN code PC1, authentication of the individual user ID “u01” is performed (T365 in FIG. 6). This enables secure application to use the MFP 10.

### Correspondence Relationships

The PIN code PC1 and the individual user ID “u01” are examples of “application information” and “user identifier,” respectively.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

In the first embodiment, the inquiry signal may include the card information 410 and the user management information UM1. The server 300 may perform the authentication of the card information 410 and the user management information UM1. The server 300 may then send an answer indicating the result of the authentication of the card information 410 and the user management information UM1 to the MFP 10. In this modification, the answer indicating the result of the authentication of the card information 410 and the user management information UM1 is an example of “predetermined answer”.

### Modification 2

In the second embodiment, the inquiry signal may not include the individual user ID “u01”, and the process of T365 may not be executed. In this modification, “execute inquiry to the server” may not utilize “user identifier”.

### Modification 3

In the second embodiment, the inquiry signal may not include the individual user ID “u01”. In this modification, the MFP 10 may receive from the server 300 a list of user ID(s) stored in association with the tenant ID “t01”. The MFP 10 may then use the list received from the server 300 to perform authentication for the individual user ID “u01” inputted in T360.

### Modification 4

In T212 in FIG. 4, the user code “zzzz” may be displayed and the user code “zzzz” may be sent using wireless communication such as NFC. In this modification, the displaying or sending of the above user code “zzzz” is an example of “output the user code”.

### Modification 5

The “communication device” may not be limited to the MFP 10, but may also be a scanner, a printer, other terminal device, a sewing machine, etc.

### Modification 6

In the above embodiment, each process in FIGS. 2 through 6 is realized by the CPU 32 executing the program 40. Instead of these, any of the process may be realized by hardware such as logic circuitry.

What is claimed is:

1. A communication device comprising:
a memory configured to store a first token which is used in access to a server on the Internet; and
a controller configured to:
in a case where the communication device receives application information for applying for usage of the communication device from a user in a situation where a state of the communication device is a first state where the usage of the communication device is not allowed, execute inquiry to the server using the application information and the first token; and
in a case where a predetermined answer indicating that the application information is registered in the server is received from the server in response to the inquiry to the server using the application information and the first token, change the state of the communication device from the first state to a second state where the usage of the communication device is allowed.

2. The communication device according to claim 1, wherein
the communication device further comprises a reader unit configured to read information stored in a tag, and
the communication device receives the application information from the user by the reader unit reading the application information from the tag.

3. The communication device according to claim 1, wherein
the application information is manually inputted to the communication device by the user.

4. The communication device according to claim 1, wherein
the inquiry is executed using a user identifier identifying the user in addition to using the application information and the first token.

5. The communication device according to claim 1, wherein
the controller is further configured to:
in a case where a first user authentication is successful in the server, receive the first token from the server, the first token being created by the server in response to success of the first user authentication and being stored in the server in association with a first user identifier which was used in the first user authentication.

6. The communication device according to claim 5, wherein
one or more user identifiers are stored in association with the first user identifier in the server,
the controller is further configured to:
in a case where a second user authentication is successful in the server after the first token has been received, receive a second token different from the first token from the server, a second user identifier of the one or more user identifiers being used in the second user authentication, and the second token being created by the server in response to success of the second user authentication and being stored in the server in association with the second user identifier; and
execute, by using the second token received from the server, a registration process for registering the application information to the server.

7. The communication device according to claim 6, wherein
the registration process includes:
sending the server an information request including the second token received from the server;
receiving specifying information stored in the server in association with the second user identifier from the server as a response to the information request; and
sending the server a registration instruction for registering the application information in association with the specifying information.

8. The communication device according to claim 7, wherein
the predetermined answer includes the specifying information.

9. The communication device according to claim 6, wherein
an organization identifier is stored in the server, the organization identifier identifying an organization to which a user identified by the first user identifier and one or more users identified by the one or more user identifiers belong,
the controller is further configured to:
in response to receiving the first token from the server, send the server an identifier request for requesting the organization identifier, the identifier request including the first token;
receive the organization identifier stored in the server in association with the first token included in the identifier request from the server; and
send the server a start instruction for instructing to start the second user authentication, the start instruction including the organization identifier received from the server.

10. The communication device according to claim 1, wherein
the first token has an expiration.

11. The communication device according to claim 10, wherein
the controller is configured to store the first token which is an access token and a refresh token, and
the controller is further configured to, in a case where the expiration of the first token has elapsed, update the first token by using the refresh token.

12. The communication device according to claim 11, wherein
in a case where the expiration of the first token has elapsed at a timing when the inquiry to the server using the first token is executed, the first token is updated by using the refresh token.

13. A non-transitory computer-readable recording medium storing computer-readable instructions for a communication device, wherein
the communication device comprises:
a memory configured to store a first token which is used in access to a server on the Internet; and
a processor, wherein
the computer-readable instructions, when executed by the processor, cause the communication device to:
in a case where the communication device receives application information for applying for usage of the communication device from a user in a situation where a state of the communication device is a first state where the usage of the communication device is not allowed, execute inquiry to the server using the application information and the first token; and
in a case where a predetermined answer indicating that the application information is registered in the server is received from the server in response to the inquiry to the server using the application information and the first token, change the state of the communication device from the first state to a second state where the usage of the communication device is allowed.
